(19) United States
(12) Patent Application Publication
(10) Pub. No.: US 2024/0104387 A1
(43) Pub. Date: Mar. 28, 2024

(54) LEARNING LOGICAL RULES OVER GRAPH STRUCTURED DATA USING MESSAGE PASSING

(71) Applicant: NEC Laboratories Europe GmbH, Heidelberg (DE)

(72) Inventors: Francesco Alesiani, Heidelberg (DE); Markus Zopf, Heidelberg (DE); Cristobal Felipe Corvalan Morbiducci, Heidelberg (DE)

(21) Appl. No.: 18/161,107

(22) Filed: Jan. 30, 2023

Related U.S. Application Data
(60) Provisional application No. 63/406,777, filed on Sep. 15, 2022.

(51) Int. Cl. G06N 3/092

(52) U.S. Cl. CPC G06N 3/092

(57) ABSTRACT

A method for learning logical rules over graph structured data to generate a prediction in a machine learning system includes obtaining graph structured data from a technical application domain of the machine learning system. A graph neural network is trained to learn logical rules using message passing. The prediction is generated in the machine learning system based on the learned logical rules.

### CROSS-REFERENCE TO PRIOR APPLICATION

Priority is claimed to U.S. Provisional Application No. 63/406,777 filed on Sep. 15, 2022, the entire disclosure of which is hereby incorporated by reference herein.

### FIELD

The present invention relates to artificial intelligence (AI) and machine learning, and in particular to a method, system and computer-readable medium for learning and using logical rules in the processing of graph structured data using message passing.

### BACKGROUND

In various technical fields and domains, ranging from social media, medicine, citation network, communication network, knowledge databases, biology, and chemistry, etc., the input data is represented as graphs, which consists of nodes that represent entities in the domain and edges that represent relationships between the nodes. Many problems exist that require inference on graph-structure data. For instance, in biology, it could be a goal to predict the binding strength of proteins with other proteins or ligands. In citation networks, it could be a goal to predict to which topic a given publication belongs. In social media, it could be a goal to predict which new connections should be recommended to a user. In knowledge bases, it could be a goal to predict missing links between nodes.

The dominant approach in machine learning for performing these tasks is based on the message passing approach, which iteratively updates node representations based on local message exchanges between neighboring nodes. Several variants of message passing have been proposed. Prominent approaches include Graph Convolutional Networks (GCNs) (see F. Scarselli, M. Gori, A. C. Tsoi, M. Hagenbuchner and G. Monfardini, “The Graph Neural Network Model,” in IEEE Transactions on Neural Networks, vol. 20, no. 1, pp. 61-80, doi: 10.1109/TNN.2008.2005605 (January 2009), which is hereby incorporated by reference herein) and Graph Attention Networks (GATs) (see P. Velielovie, G. Cucurull, A. Casanova, A. Romero, P. Lio, and Y. Bengio, “Graph Attention Networks,” Proceeding of the 6th International Conference on Learning Representations, pp. 1-12 (2018), which is hereby incorporated by reference herein). These approaches are based on purely continuous message passing.

### SUMMARY

In an embodiment, the present invention provides a method for learning logical rules over graph structured data to generate a prediction in a machine learning system. The method includes obtaining graph structured data from a technical application domain of the machine learning system. A graph neural network is trained to learn logical rules using message passing. The prediction is generated in the machine learning system based on the learned logical rules.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a method and system for learning logical rules over graph structured data according to an embodiment of the present invention including the main inputs and outputs of the system;

FIG. 2 schematically illustrates the message passing for a satisfiability problem according to an embodiment of the present invention;

FIG. 3 schematically illustrates training of a model according to an embodiment of the present invention;

FIG. 4 schematically illustrates learning with a contrastive loss according to an embodiment of the present invention;

FIG. 5 shows methane and ethane as a simplified exemplary use case of learning logical rules;

FIG. 6A schematically illustrates the message passing for the use case of FIG. 5 according to an embodiment of the present invention;

FIG. 6B schematically illustrates the variables used in the message passing of FIG. 6A;

FIG. 7 schematically illustrates batch aggregation according to an embodiment of the present invention;

FIG. 8 shows two graphs which cannot be distinguished by a standard graph neural network, but are distinguishable using embodiments of the present invention; and

FIG. 9 shows one-hop and two-hop adjacency matrices for the two graphs of FIG. 8.

### DETAILED DESCRIPTION

Embodiments of the present invention provide a method, system and computer-readable medium for learning logical rules over graph structured data which can be practically applied to improve various technical fields applying machine learning. For example, in one embodiment, a practical application is a biomedical application, such as molecular property prediction and/or drug development. Embodiments of the present invention can be advantageously applied to achieve improvements in graph structured machine learning problems generally by being able to learn and use the logical rules.

Graph-structured problems appear in a wide range of technical fields and domains such as chemistry, biology, and computer science. However, current approaches for learning on graphs do not account for the logical nature that determine its properties. In contrast, embodiments of the present invention introduce a continuous-discrete approach for learning on graphs that learns and uses logical rules to guide the information diffusion within graphs during learning and inference.

Embodiments of the present invention recognize that existing machine learning systems that are based on purely continuous message passing is problematic for several reasons. First, continuous message passing does not account for the fact that several prediction problems are determined by logical rules, e.g. in knowledge graphs or communication networks. Continuous message passing that does not integrate logical reasoning is not a good fit for machine learning problems such as those listed above. Second, continuous message passing does not allow integration of prior domain knowledge and does not allow enforcing constraints during message diffusion. Third, continuous message passing is not interpretable and thus has a limited applicability, e.g. in limited- and high-risk domains according to the European Union Artificial Intelligence Act.

Embodiments of the present invention provide a method for continuous-discrete inference on graph-structured data, as well as two machine learning methods to train the proposed model. The method for continuous-discrete inference on graph-structured data is a trainable method that performs tasks on graph-structured data such as node classification, link prediction, and graph classification. At training time, graph-structured data is consumed as input. Additionally, a set of predefined rules/constraints can be fed to the model. Based on the inputs, the model uses its internally stored logical rules to perform one or multiple rounds of continuous-discrete message passing to learn new node representations such that each node gets a new feature in each round. The new features are then used with another maximum satisfiability (MAXSAT) solver to output a new feature as input for the next level. Finally, the obtained node representations are used to solve the prediction problem. More specifically, once each node has obtained an appropriate feature representation, which is computed after various layers of aggregation and transformation, it is possible to either use directly the node feature to predict, for example, if the node participates in the attention subgraph or aggregate the node features using a similar mechanism to generate a graph feature. The output can be implemented using a MAXSAT read out function.

According to a first aspect, a method for learning logical rules over graph structured data to generate a prediction in a machine learning system includes obtaining graph structured data from a technical application domain of the machine learning system. A graph neural network is trained to learn logical rules using message passing. The prediction is generated in the machine learning system based on the learned logical rules.

According to a second aspect, the method according to the first aspect further comprises obtaining an initial set of logical rules that are usable to solve a satisfiability problem in the technical application domain of the machine learning application, wherein the graph neural network is trained to learn updates to the initial set of logical rules to provide new learned rules.

According to a third aspect, the method according to the first or the second aspect is provided, wherein the initial set of logical rules are predefined using domain knowledge.

According to a fourth aspect, the method according to any of the first to third aspects further comprises computing an attention bit that is used to decide whether a feature of a node of the graph neural network is included in the message passing.

According to a fifth aspect, the method according to any of the first to fourth aspects is provided, wherein a plurality of attention bits are computed, each for a respective node of the graph neural network, and wherein the nodes are ordered prior to aggregation by the message passing based on the attention bits.

According to a sixth aspect, the method according to any of the first to fifth aspects is provided, wherein the training is performed end-to-end with a differentiable satisfiability solver.

According to a seventh aspect, the method according to any of the first to sixth aspects is provided, wherein the training is performed using reinforcement learning.

According to an eighth aspect, the method according to any of the first to seventh aspects, further comprises generating two graph sequences from the graph structured data by dropping edges or nodes randomly, wherein the graph neural network generates a representation for each of the graph sequences, and wherein the training is performed using a contrastive loss based on the representations.

According to a ninth aspect, the method according to any of the first to eighth aspects is provided, wherein the loss is built by minimizing a Kullback-Leibler (KL) divergence of the representation, by maximizing mutual information and/or using a cosine similarity function.

According to a tenth aspect, the method according to any of the first to ninth aspects further comprises ordering nodes of the graph neural network prior to aggregation by the message passing.

According to an eleventh aspect, the method according to any of the first to tenth aspects is provided, wherein the ordering is based on values of the features of the nodes.

According to a twelfth aspect, the method according to any of the first to eleventh aspects is provided, wherein the message passing performed by a node of the graph neural network uses the logical rules to aggregate information from other nodes and/or to transform information from the same node to another layer of the graph neural network.

According to a thirteenth aspect, the method according to any of the first to twelfth aspects is provided, wherein the technical application domain is in medical artificial intelligence, bioinformatics and/or knowledge graphs, and wherein the prediction is an output of the graph neural network trained on a machine learning task that is a node classification, a link prediction and/or a graph classification.

According to a fourteenth aspect, a system for learning logical rules over graph structured data to generate a prediction in a machine learning system, comprises one or more hardware processors, configured to provide for execution of the following steps: obtaining graph structured data from a technical application domain of the machine learning system; training a graph neural network to learn logical rules using message passing; and generating the prediction in the machine learning system based on the learned logical rules, or to provide for execution of any method according to any of the first to thirteenth aspects.

According to a fifteenth aspect, a tangible, non-transitory computer-readable medium has instructions thereon which, upon being executed by one or more processors, provides for execution of a method for learning logical rules over graph structured data to generate a prediction in a machine learning system according to any of first to thirteenth aspects.

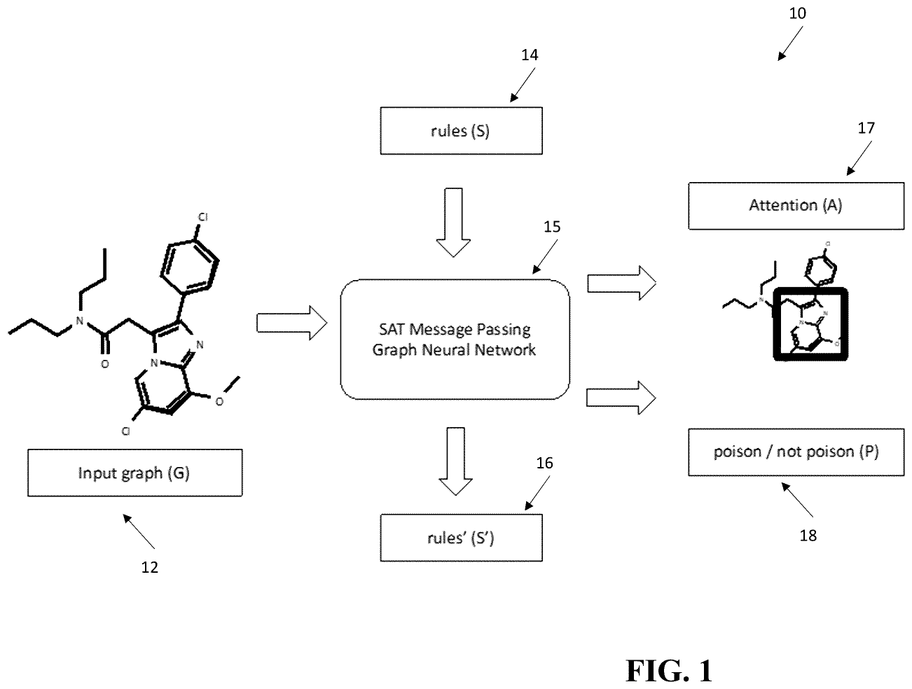

FIG. 1 schematically illustrates a method and system 10 for learning logical rules 16 over graph structured data from an input graph 12 according to an embodiment of the present invention including the main inputs and outputs of the system 10. The graph structured data from the input graph 12 is input to the graph neural network 15 which utilizes message passing in accordance with an embodiment of the present invention. An attention bit 17 can be added to the features for guiding the graph neural network 15 to select the relevant features. The graph neural network 15 acts as a SAT solver or a differentiable reasoning component that solves a SAT or MAXSAT problem. Preferably, an initial set of logical rules 14 that can be updated, wherein some rules may be fixed, is also provided as input to the graph neural network 15. Solving the SAT or MAXSAT problem using the learned logical rules 16 provides for making a prediction in a machine learning system, which in the embodiment of FIG. 1 is for chemical compounds and the prediction 18 is whether the compound is poisonous or not.

A MAXSAT is an extension of the satisfiability problem (SAT). SAT is the problem of, given a set of rules sⱼᵢ, to find a set of variables xᵢ or features that satisfy the set of rules. The rules can be specified in the conjunctive normal form (CNF) form that consists of a series of clauses joined by the and operator, for example:

(s₁₁x1V s₁₂x2 . . . V s₁ₙxₙ)∧ . . . ∧(Sₘ₁x₁V sₘ₂x₂. . . V sₘₙxₙ)

where m is the number of rules and n is the number of logic variables, where s11 is the first rule on the first variable (e.g., s₁₁ can be a negation or removal of the first variable for the evaluation of the condition with respect to the first rule), s₁₂ is the first rule on the second variable, etc., and x₁ is the first logic variable, x₂ is the second logic variable, etc.

The MAXSAT problem extends the SAT problem by finding the set of variables x₁ . . . xₙ that maximizes the number of “or” clauses (sⱼ₁ x₁ V sⱼ₂ x₂ . . . V sⱼₙ xₙ) that are satisfied (i.e., true).

The pipeline is designed as a differentiable pipeline such that it can be trained end-to-end with gradient-based optimization or reinforcement learning methods.

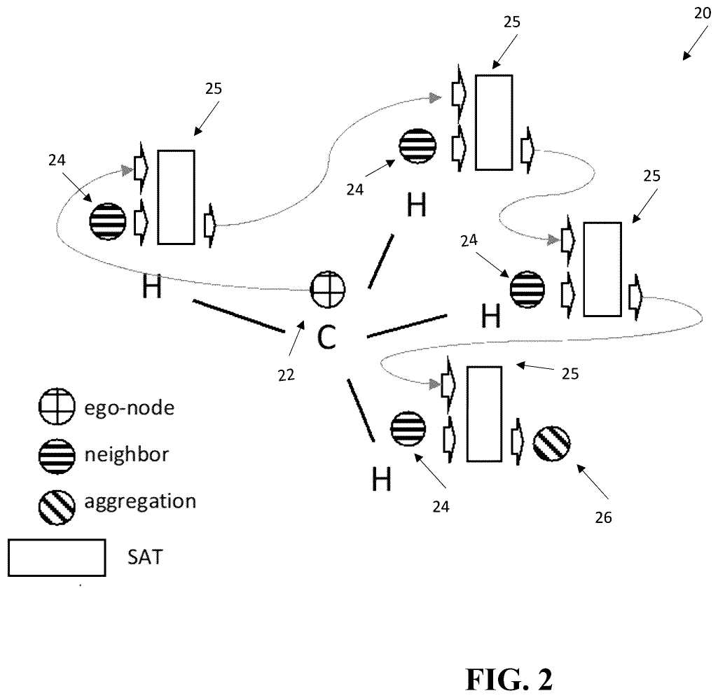

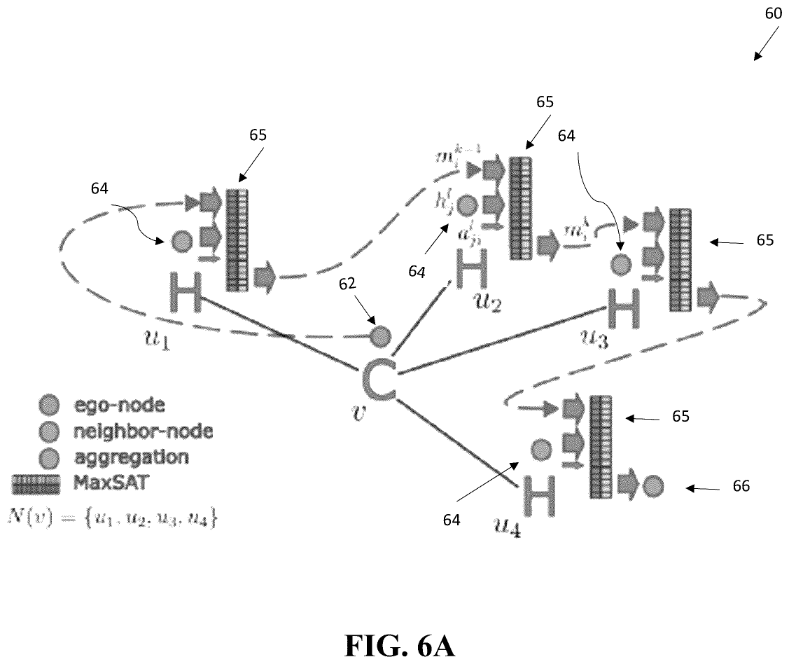

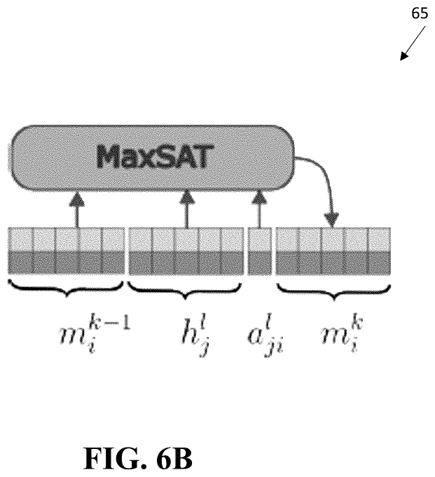

FIG. 2 schematically illustrates the message passing 20 for a SAT or MAXSAT problem according to an embodiment of the present invention using a methane molecule and the carbon atom thereof as the current central ego-node 22, and the carbon atoms as the neighbor nodes 24. The inputs to the SAT solvers 25 include the messages indicated by the arrows from a neighboring one of the nodes 22, 24, the messages including the node features and potentially other information such as edge features, and the messages or node features are aggregated as the aggregation 26. FIG. 6A shows another embodiment of message passing 60 in more detail, similarly using a methane molecule and the carbon atom thereof as the current central ego-node 62, and the carbon atoms as the neighbor nodes 64, as well as MAXSAT solvers 65 which are similar to the SAT solvers 25, and which use an attention bit an ti to help the MAXSAT solvers 65 decide if a variable or feature on a node (see FIG. 6B) is used during the message passing 60.

The message generation and node representation update during message passing can happen using a memory feature mᵢ, such that mᵢ′=MAXSAT(mᵢ, hᵢ), where mᵢ is the message from/to the ego node i or a message associated to an edge between two nodes (i, j), where hⱼ is the feature at the node j. The memory feature mᵢ at the beginning is either learnable or set to mᵢ=hᵢ. Alternatively, it is possible to have a single MAXSAT problem that processes K inputs at the same time as MAX-mᵢ=SAT(h₀, . . . h_{K-1}), where h₀, . . . h_{K-1} are features from the neighbor node(s), where K of them are selected.

The message passing uses the logical rules to:
1. Aggregate information from other nodes.
2. Transform information of the same node from one layer to the next.

For example, the following pseudocode including logical rules could be used for the message passing:

```
For nᵢ in Nodes:
  m = 0
  for nⱼ in Neighbor of ni:
    m[nᵢ] = F(m[nᵢ],h[nⱼ])
  h[nᵢ] = G(h[nᵢ],m[nᵢ])
```

where F and G are two neural networks and these steps happen at each layer, and where h[nᵢ] and h[nᵢ] are the features of nodes nᵢ and nᵢ, while m[nᵢ] is the message of node nᵢ.

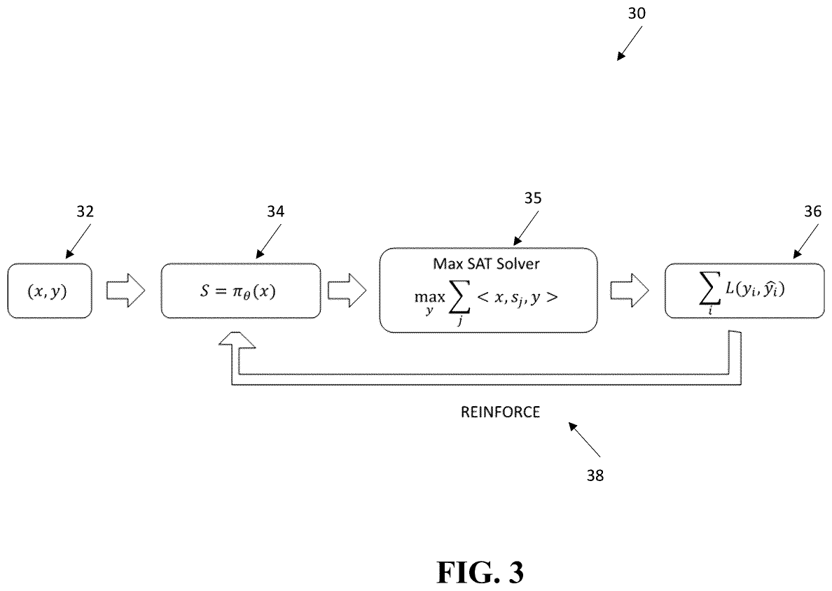

According to embodiments of the present invention, there are two different ways to train the proposed model. The first option is to use end-to-end training with a differentiable satisfiability solver such as SAT-NET (see P. W. Wang, P. L. Donti, B. Wilder and Z. Kolter, “SatNet: Bridging deep learning and logical reasoning using a differentiate satisfiability solver,” 36th International Conference on Machine Learning, pp. 11373-11386 (2019), hereinafter Wang et al., which is hereby incorporated by reference herein). The second option is to use the well-known REINFORCE algorithm to learn rules according to the reinforcement learning paradigm. A genetic algorithm can be used to guide the discovery of the rules during training. Referring to FIG. 3, a method 30 for training the model is shown, wherein the MAXSAT solver 35 receives inputs 32, 34, where x is the input and S represents the rules, and the MAXSAT solver provides an output 36, where y is the solution, and L is a loss function which is used by the REINFORCE algorithm 38 to learn/adjust the rules. The MAXSAT solver 35 solves for y, given the inputs 32, 34 of x and S. The loss function L is, for example, a cross binary loss function, hamming distance (x*(1−y)+(1−x)*y), or other binary or non-binary loss function. In the MAXSAT solver 35 is differentiable, then it is not necessary to use the REINFORCE algorithm 38.

Alternatively or additionally, SAT-NET can be used, where the propagation of gradient is based on solving a relaxed MAXSAT problem, where the problem is:

$${min}_{X} 〈 {S}^{T} S , {X}^{T} X 〉$$

$$s . t . ‖ {x}_{i} ‖ = 1 , ∀ i$$

where X is the set of variables such that xᵢ ∈ R^{k} with k being the dimension of an embedding space, T is the transpose of a matrix (columns and rows exchanged), and R is the set of real numbers.

It is possible to then recover the binary variable in probability using:

$$P ( {x}_{i} = 1 ) = \frac{{cos}^{- 1} ( - {x}_{i}^{T} {x}_{0} )}{π}$$

where x₀ is a variable defining the truth value.

In an embodiment, the present invention provides an ordering bit by which the features are ordered before aggregation to improve the performance of the approach. The bit is a continuous variable used to order the nodes based on the features. Additionally or alternatively, the following steps are performed:
1. A fixed ordering mechanism based on the value hⱼ,
2. Ordering the attention bit, where the attention is computed αᵢⱼ=ƒ_{θ}(hᵢ, hⱼ), where A is a learnable function of parameter θ, i is the ego node and j is the current node that is being aggregated. The parameter θ is the parameter of the attention function ƒ_{θ} and is learned in an end-to-end manner such that its value is not known in advance.

For example, the nodes could be ordered using their features. Then, an variable can be added to indicate the attention for the nodes. This variable can be continuous (e.g., between 0 and 1), or discrete (e.g., 0 or 1), and used by the neural network to decide whether to use a node feature. If the attention bit is 0, then the node feature can be ignored, or if 1, then the node feature can be used, while other values can be used as a probability of using the node features.

In an embodiment, the present invention provides an attention bit. Each feature is combined in the aggregation with the attention bit that is used to guide the MAXSAT solver whether to include the current node feature hⱼ.

In an embodiment, the present invention provides for multi-rule set attention (multi-head). Here, it is provided to have multiple MAXSAT solvers, each with its own rule set Sₖ, and a bit is used to decide whether to aggregate the output from this ruleset in following layers MAXSAT (a₀, m₀, . . . , a_{K}, m_{K}), where mₖ are the distinct parallel memory computed on the same input, as follows:

$${h}_{i}^{′} = {\sum }_{k = 1 , … , K} {a}_{k} ( {h}_{i} ) {m}_{k}$$

where hᵢ′ represents the node variable or node feature, mₖ is the result of the message passing with a specific set of rules Sₖ on the node i over all its neighbors j∈Nᵢ as follows:

$${m}_{k} = MP ( {h}_{i} {\{ {h}_{j} \}}_{j ∈ {N}_{i}} , {S}_{k} )$$

where the set of rules Sₖ is trainable.

Embodiments of the present invention preferably apply contrastive loss training. Alternatively or additionally, the training can be unsupervised and/or use a self-supervised signal. The contrastive learning can be used as a separate signal to train or to create an initial network that is then used for the supervised learning.

The same network is given as input a sequence of graphs {xᵢ}, where two new sequences are generated {xᵢ₁} and {xᵢ₂} from {xᵢ} where edges or nodes are dropped randomly. From each graph xᵢ*, the MAXSAT neural network generates the representation b_{i*}, and then builds an additional loss to train the MAXSAT message passing graph neural network.

The loss is built in the following ways:
1. By minimizing the Kullback-Leibler (KL) divergence of the representation:

KL(bᵢ₂|bᵢ₁)<KL(bᵢ₂|bⱼ₁),∀j≠i

which is computed as:

$$min KL ( {b}_{i 2} \vert {b}_{i 1} ) - β {\sum }_{j \neq i} KL ( {b}_{i 2} \vert {b}_{j 1} ) , ∀ j \neq i$$

2. Alternatively or additionally, it is possible to use the mutual information maximization as follows:

$$max Mi ( {b}_{i 2} ; {b}_{i 1} ) - β {\sum }_{j} MI ( {b}_{j 2} ; {b}_{i 1} )$$

where MI is the mutual information used to measure the mutual dependence of two random variables.
3. Alternatively or additionally, it is possible to use the cosine similarity function σ(bᵢ₂; bᵢ₁) (see Y. You, T. Chen, Y. Sui, Z. Wang, and Y. Shen, “Graph contrastive learning with augmentations,” Advances in Neural Information Processing Systems, vol. 33, pp. 5812-5823 (2020), which is hereby incorporated by reference herein) as follows:

$$max \frac{exp σ ( {b}_{i 2} ; {b}_{i 1} ) / τ}{{\sum }_{j \neq i} exp σ ( {b}_{j 2} ; {b}_{i 1} ) / τ} , σ ( {b}_{i} ; {b}_{j} ) = \frac{{b}_{i}^{T} {b}_{j}}{\vert {b}_{i} \vert \vert {b}_{j} \vert}$$

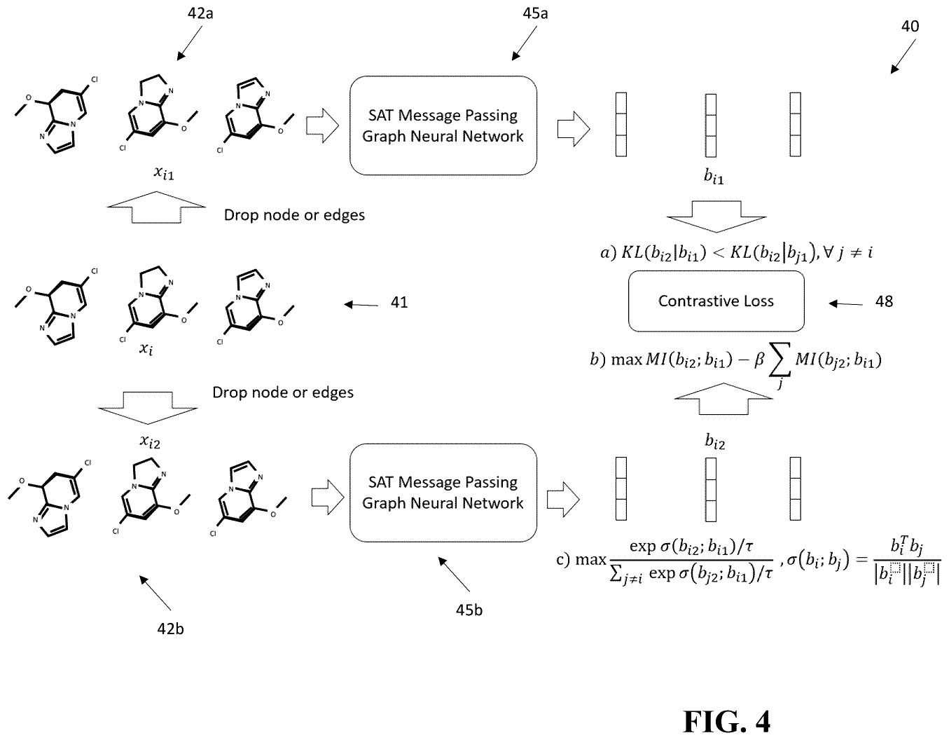

FIG. 4 schematically illustrates a method and system for the contrastive learning for the MAXSAT multiphysical graph neural network (MP-GNN). Two sequences of graphs 42a, 42b are generated from the original graph sequence 41 (batch) and then after running through respective models of the graph neural networks 45a, 45b, the two generated logical representations sequences that are output are used to build the contrastive loss 48. Any or all of the loss formulations a), b) or c) in FIG. 4 can be used to determine the contrastive loss 48.

Embodiments of the present invention can be practically applied to improve machine learning generally, in particular by providing the logical rules to improve machine learning tasks using graph structured data, and to effect technical improvements in various technical fields, such as automated healthcare, automated transport systems, chemical or drug discovery or selection, bioinformatics, link selection for knowledge graph-based tasks and materials science.

For example, an embodiment of the present invention can be applied for molecular property prediction for drug discovery (medical AI, bioinformatics). Here, several properties of molecules are known to be causally dependent on a small subset of the nodes representing the full molecule. Logical rules can be learned from molecules with known properties by using an embodiment of the present invention and can be applied to infer properties of new, potentially not yet synthesized molecules, which substantially accelerates the drug discovery process. Also, one could consider the problem of predicting the property of a chemical compound, for example when it would be desired to determine if a new drug has an adverse allergic reaction or could cause poisoning. This can provide a link to the presence of a specific substructure or element in the molecular structure that generates the reaction (property) when used. The system according to an embodiment of the present invention then, at inference time, gets a new unseen molecule represented as a graph, possibly with some rules from domain experts to generate an adverse reaction plus the automatically learned rules. The output is the prediction if the molecule is dangerous and which part of the molecule is responsible for the reaction (property). A domain expert can include domain knowledge in the form of logical rules that are used in solving the MAXSAT problem. At the end of the training, the new learned rules can be extracted from the learned network. When using the contrastive loss, the generation of the two sequences can be done using some domain knowledge, for example changing the graph such that some properties are maintained.

Another embodiment of the present invention can be applied for link prediction in knowledge graphs. Knowledge graphs are known to be incomplete and noisy (i.e., containing incorrect links). For instance, in knowledge graph alignment, missing links between similar entities need to be predicted to connect data from different databases. In recommender systems, a user may want to predict a new, potentially beneficial customer relation for a company. In addition, incorrect links need to be detected and removed from knowledge graphs to prevent malfunctions of subsequent usage of the knowledge graph. Many relations in knowledge graphs can be expressed by logical rules. Well-known relations such as parent-child relations or customer-company relations are determined by logical rules. Embodiments of the present invention can be advantageously applied to learn those rules from data and can be used to perform inference on seen and unseen data. Hence, rules do not have to be hand-engineered by human experts, but can be advantageously learned automatically by using embodiments of the present invention.

A further embodiment of the present invention can be applied for property prediction of a new material in material informatics (material informatics). The properties of materials and chemical compounds in material informatics may be determined by a set of logical rules. The logical rules learned by embodiments of the present invention can be used to predict properties of materials and chemical compounds before they are produced, thereby conserving time and resources during the development process of new materials.

Embodiments of the present invention enable the following technical improvements and advantages over existing technology:
1. Providing for the processing of information on graph structured data using learnable rules (via the MAXSAT problem) and using message passing processing with node ordering to insure permutation invariance,
   a. where:
      i. the rules can be partially pre-defined and other rules can be learned during the training,
      ii. an attention bit is used to decide if a variable on a node is used during the message passing and there are multiple sets of rules,
      iii. the use of the set of rules is decided by an attention mechanism (multi-head),
      vi. the order of the variables is decided by an ordering mechanism that is trainable using an ordering bit (scalar value), ensuring permutation invariance of the overall method, and
      v. the scalar value can be defined on the same variable value or by using the current and the ego variable or any other variable,
   b. and a method for providing such processing, according to an embodiment, comprises:
      i. setup a machine learning system that implements an embodiment of the present invention,
      ii. optionally, specify prior knowledge to be used or constraints to be met by the model,
      iii. choose a training approach, e.g., end-to-end training via a differentiable satisfiability solver or training via reinforcement learning,
      vi. if contrastive learning is used, generate two sequence of graphs and build the contrastive loss that is used as a self-supervised signal,
      v. train the model,
      vi. obtain the learned model/logical rules,
      vii. apply the learned model/logical rules to perform inference in a machine learning task, e.g., missing link prediction or molecule property prediction, and
      viii. extract the learned rules from the trained model.
2. The method according to embodiments of the present invention learns logical rules, which are used to make predictions at inference time and thus fits well and enables technical improvements in technological fields and domains that are governed by logical rules such as knowledge graphs or chemical molecules.
3. The model according to embodiments of the present invention enables to integrate prior knowledge that is encoded in logical rules into the model since the model is based on logical rules. Moreover, it is not only possible to integrate rules, but also to specify logical constraints that restrict or guide the models output.
4. The model according to embodiments of the present invention based on logic rules is easier to interpret than MP-based models, which may be an especially significant improvement relative to MP-based models as soon as the EU AI Act is implemented, which may prohibit the application of not interpretable MP-based models in many technical fields and domains including healthcare, public transport, education and public safety, etc. to which embodiments of the present invention can be practically applied.
5. Enables to integrate domain knowledge.
6. Provides insight of how things work inside (e.g., allows for rules inspection).

In the method, the message passing is either implemented in bulk or recursively.

By adding multiple rules, the neural network can automatically decide which rule to apply based on the attention variables. Alternatively, all the rules can be applied at the same time and then the neural network can use the attention variables to only select the results that are more appropriate for the specific input. Everything is learned end-to-end.

In another embodiment, the present invention provides a method for learning logical rules over graph structured data for making a prediction in a machine learning system, the method comprising:
1. Obtain graph structured data from the application domain (e.g. knowledge graphs, proteins, chemical compounds, etc.).
2. Perform the processing steps b.i.-b.viii. above of the method of processing of information on graph structured data using learnable rules and using message passing processing of the embodiment described above.
3. Obtain the inference results and use the results for an automated decision in a machine learning task, e.g., to make decisions during a drug discovery process or to recommend to companies new, beneficial customers.

Embodiments of the present invention introduce the use of logical rules for message passing. It has been discovered that embodiments of the present invention perform better than existing models in some applications, and at least on par with existing models in other applications, while providing the other improvements discussed herein.

Embodiments of the present invention can be used in any problem that has a graph-structured input. Most importantly, applications that use a knowledge graph (such as Material Informatics and TME projects), BAI projects that model gene, ligand, or protein interactions, and NLP projects that model interactions between linguistic elements such as de-duplication of documents and applications of knowledge graphs.

Embodiments of the present invention learn and use logical rules to perform message passing and inference for graph-structured data, as opposed to, e.g., an arbitrary non-linear function. Further, domain expert rules can be added and the system extracts logical rules. Notably, the integration of prior knowledge via logical rules is only possible if the model uses logical rules.

In the following, further exemplary embodiments of the present invention are described. To the extent different terminology is used in the following to describe analogous features in embodiments of the present invention discussed above, people having ordinary skill in the art will understand the different terminology to describe the same or similar features. It will also be understood that any features of embodiments of the present invention described in the following can be used in various combinations with features of embodiments of the present invention described above.

The message passing principle is used in the most popular neural networks for graph-structured data. However, existing message passing approaches cause several issues such as over-smoothing, under-reaching, and over-squashing, which limits the performance of graph neural networks (GNNs). Further, traditional neural networks fail to model reasoning over discrete variables. Embodiments of the present invention, which are also referred to as MAXSAT-GNN, provide a type of message passing based on a differentiable satisfiability solver, wherein the model learns logical rules that encode which and how messages are passed from one node to another node. The rules are learned in a relaxed continuous space, which renders the training process end-to-end differentiable and thus enables standard gradient-based training. Experiments show that MAXSAT-GNN learns arithmetic operations and is on-par with state of art graph neural networks.

Graph-structured data can be found in many domains such as biology, chemistry, and computer science. Consequently, machine learning for graph-structured data is gaining more interest from the machine learning community. A key component of neural networks for graph-structured data (so-called graph neural networks) is the message passing principle. The key idea of message passing is to exchange messages between nodes in a graph such that representations for nodes or the graph can be learned. The obtained representations are used to address tasks such as node classification, graph classification, and missing node feature prediction.

Even though message passing is used in many graph neural networks, it is far from being perfect. On the contrary, several technical issues with message passing have been reported in prior works. Graph neural networks exhibit over-smoothing, over-squashing, under-reaching and/or limited expressive power. In addition to these shortcomings, experiments have shown that existing neural networks fail to reason over discrete variables (or combinatorial problems), as for example in learning and generalizing elementary arithmetic operations.

Embodiments of the present invention provide an improved way of message passing, in which logic rules (which could model for example binary arithmetics) are learned end-to-end with a differentiable satisfiability solver to encode how messages are distributed within the graph. By modeling the node features as logical variables, it is possible to describe the relationship of those features over the neighbor nodes using one or more logic sentences. A feature is propagated over neighbor nodes only if correct according to the graph logic rules.

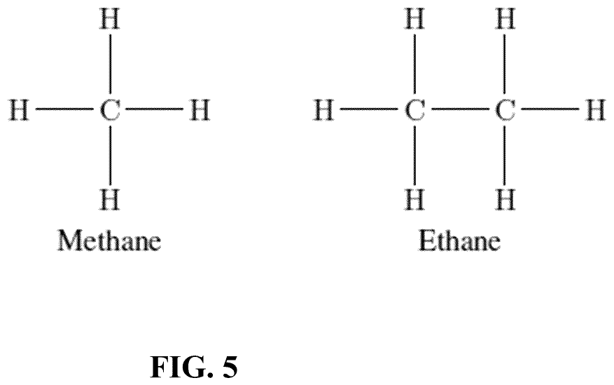

For example in the exemplary use application of FIG. 5 showing methane and ethane molecules, the difference is in the presence of specific sub-structure or the abundance of specific atoms, in particular the variable describing if the molecule is methane or ethane is set based on the number of hydrogen atoms around the carbon atom and the presence of one or two carbon atoms. It is thus assumed that a collection of logical rules can be collected at the level of the single atom and then verified by pooling the logical variables at the level of the whole graph.

According to embodiments of the present invention, MAXSAT-GNN is a continuous-discrete approach and provides for a number of technological improvements over existing approached such as data efficiency and interpretability. For example, in the arithmetics experiments the number of sentences is limited. Moreover, experiments show that the approach according to embodiments of the present invention exceeds the accuracy of existing message passing approaches in several tasks.

With respect to notation, an undirected graph is a pair G=(V_{G}, E_{G}), where V_{G}={ [symbol] ₁, . . . , [symbol] _{N}} is a finite set of vertices (also called nodes), and E_{G}⊆{{u, [symbol] }: u, [symbol] ∈V_{G}, u≠ [symbol] }: is a symmetric, irreflexive, binary relation on V_{G}. The elements in E G are called edges. [symbol] ( [symbol] )={u: { [symbol] , u}, u∈V, { [symbol] , u}∈E_{G}} denotes the neighborhood of v and |·| denotes the size of a set. For a column vector h, h^{T} is its transpose.

Embodiments of the present invention can be practically applied to solve SAT and MAXSAT problems. SAT problems consist of a set of Boolean variables that are related by a logical structure, in other words, elements related by logic rules. In general, the rules that govern the relationship between those elements can be represented in conjunctive normal form (CNF), which consists of a series of clauses joined by AND operators. CNF can represent any propositional logic. Each of the clauses may contain some of the variables, or their negation, as follows:

(s₁₁x₁V . . . Vs₁ₙxₙ)∧(s₂₁x₁V . . . Vs₂ₙxₙ)∧ . . . ∧(sₘ₁x₁V . . . V sₘₙxₙ) (1)

where sⱼᵢ determines whether the variable xᵢ∈{⊥, T} (⊥ is the logic false value, and T is the logic true value, and, in the following, the true value will be mapped to +1, while the false value into −1) is present and/or negated in clause j, for example if s₁₁=1 then x₁ participates in the first clause, while if s₁₁=−1 then x₁ is negated into [symbol] x₁, while if s₁₁=0 then x₁ is not present. The objective of the SAT problem is to find the truth values of the variables so that the CNF statement is fulfilled.

Embodiments of the present invention can also be practically applied to the optimization analog of the SAT problem (MAXSAT), where the goal is to find a configuration of variables so that the amount of fulfilled clauses is maximized. SAT-NET is a MAXSAT solver that can be incorporated into more complex network architectures to solve a MAXSAT problem while it learns the logical structure of the MAXSAT in a continuous and differentiable way. SAT-NET shows great success in binary encoded prediction problems such as the parity problem and Sudoku puzzles

The SAT-NET solver is a satisfiability solver that maps the variables and parameters of the MAXSAT problem into a continuous high-dimensional space. This relaxation allows to write the MAXSAT problem as a Semi-Definite Programming (SDP) problem and solve it using fast block coordinate descent techniques. It is built so it can be integrated as a layer of a more complex machine learning algorithm since the SDP loss function can be optimized with respect to the differentiable parameters of the MAXSAT.

Given a MAXSAT problem with n variables m clauses, the variables of the SAT problem are denoted as xᵢ∈{−1, 1} for i∈{1, . . . n}, where xᵢ represent the truth value of each of the i-th variable. Let sⱼᵢ ∈{−1, 0, 1} denote the parameters of the SAT for i ∈{1, . . . n} and j∈{1, . . . m}. The value of sⱼᵢ represents the sign (if present) of variable xᵢ in clause j. The MAXSAT problem consists of finding the values of xᵢ so that the sum of fulfilled clauses is maximized as follows:

$${max}_{x ∈ {\{ - 1 , 1 \}}^{n}} {\sum }_{j = 1}^{m} {⋁}_{i = 1}^{n} \{ \begin{matrix}1 & {s}_{ji} {x}_{i} > 0 \\ 0 & otherwise\end{matrix} \qquad ( 2 )$$

The MAXSAT problem is relaxed to form an SDP. First, the SAT variables xᵢ are given a probabilistic interpretation, allowing them to be in the interval P(xᵢ=1)∈[0, 1]. Usually, inputs are binary encoded and are discrete, but the MAXSAT solver based on SAT-NET allows non-discrete inputs. Second, the probabilistic variables are relaxed by a map into the k-dimensional sphere: P(xᵢ=1)∈[0, 1]→x̅ᵢ∈S^{k-1} ⊂ [symbol] ^{k}, with ∥x̅ᵢ∥=1 and S^{k-1}={x̅∈ [symbol] ^{k}:∥x̅∥1}. The probabilistic variables and the relaxed ones are related by an auxiliary variable x̅₀ that is introduced as a truth-direction. The probability of xᵢ being true will be related to the projection of the relaxed variable in the truth direction:

P(xᵢ=1)=cos⁻¹(−x̅ᵢ^{T}x̅₀)/π (3)

Additionally, the coefficients sⱼᵢ are also mapped into the real numbers s̅ⱼᵢ∈ [symbol] , and an additional coefficient s̅ⱼ₀=−1 is introduced. The MAXSAT problem in Equation (2) can be expressed in the following SDP form:

$${min}_{\overline{X}} 〈 {S}^{T} S , {\overline{X}}^{T} \overline{X} 〉 , such that ‖ {\overline{x}}_{i} ‖ = 1 ∀ i \qquad ( 4 )$$

where X̅∈ [symbol] ^{k×(n+1)} and S∈ [symbol] ^{m×(n+1)} are the matrices formed by the column vectors x̅ᵢ and s̅ᵢ/\sqrt{4∥s̅ᵢ∥} respectively. Given a set of known parameters S, the MAXSAT problem represented as in Equation (4) is solved via a block coordinate descent method that converges to the optimal global point of the SDP. The solutions of the MAXSAT problem x̅ᵢ∈S^{k-1} are mapped back to a probabilistic value using Equation (3).

Given an assignment of the learnable parameters S, the SAT-NET solver solves in a forward pass the MAXSAT problem. Wang et al. provide an efficient way to back-propagate gradients with respect to parameters S. In other words, this module can be combined with existing machine learning differentiable methods to learn the rules of a MAXSAT problem encoded in the parameters of the S matrix. The complexity of solving Equation (11) (see Wang et al.), for both forward and backward steps, is O(knmT), with T being the maximum number of iterations. In the following, y=MAXSAT_{M}^{N}(x) is used to denote a MAXSAT problem with N logic variables and M clauses, where the input variable x∈[0, 1]^{d}^{ₓ} and output variables y∈[0, 1]^{d}^{_{y}} have a combined size of dₓ+d_{y}=N. Whenever multiple inputs x₁, x₂, . . . are presented to the MAXSAT solver, these are concatenated in a single input x.

According to embodiments of the present invention, message passing consists of three steps. First, for each pair of connected nodes u, v, a message m( [symbol] , u) is computed. Second, for each node v, all messages m( [symbol] , u) with u∈ [symbol] ( [symbol] ) are aggregated. Third, the node representation of node v is updated based on the aggregated messages. Embodiments of the present invention do not distinguish between the node's feature h [symbol] and the edge message m( [symbol] , u) during aggregation.

In MAXSAT-based message passing according to embodiments of the present invention, a message aggregation procedure is used where neighboring nodes' features, associated with a central node, are logically related to the updated central node's feature through an unknown MAXSAT problem (a set of logic rules). The motivation for such a procedure lies in the discovery that the information carried across graph edges and the updated nodes can be represented as a set of truth variables. The logic rule that fulfills the MAXSAT problem related to them can in principle be learned and computed from the neighbor nodes and is inherent to the nature of information represented in the graph.

FIG. 6A is a visualization of message passing 60 including message passing aggregation for a MAXSAT problem according to an embodiment of the present invention using the methane molecule from FIG. 5, where the carbon atom is the current ego-node 62 and the hydrogen atoms are the neighbor nodes 64. FIG. 6B illustrates the variables of the MAXSAT solvers 65. The neighbor nodes 64 are visualized according to the adopted notation. The neighbor nodes 64 as N ( [symbol] ) are first ordered and then aggregated to an aggregation 66 using Equation (5). The attention bit aⱼᵢ^{l} helps the MAXSAT solvers 65 to select the relevant features hᵢ^{l} for the messages mᵢ.

MAXSAT-based message passing as introduced in embodiments of the present invention benefits from two features. First, it works based on the logic behind the data, which makes it a useful tool for data encoded with binary labels. The representation of this data does not possess a natural ordering commonly used by a standard aggregation scheme, like mean or max functions. Second, the model is capable of carrying interactions between neighboring node features through a memory. Those interactions can be captured at the moment of aggregation.

In the model according to embodiments of the present invention, a differentiable rule learning approach is used to learn the MAXSAT problem behind the aggregation. Node features and aggregated messages will therefore acquire a probabilistic nature according to the relaxation process.

Embodiments of the present invention provide an aggregation function over neighbors and message passing using recursive MAXSAT, which is described in more detail on a single graph neural network layer. Given a central node i, the input of the model is the set of all neighbors' node features of that node plus the central node feature itself, encoded as binary truth values: hᵢ^{l}, hⱼ^{l}∈[0, 1]^{d}^{ₗ} for j∈ [symbol] (i), where dₗ is the dimensionality of the features at the l-layer, where the logic value is represented as a probability (Equation (3)).

The aggregation function over the neighbors of a node is implemented recursively similar to recurrent networks, where the aggregation step uses a MAXSAT solver. For the experiments, SAT-NET was used. This is also referred to herein as R-MAXSAT-GNN for recursive MAXSAT graph neural network. Using node i and the set of its neighbor features hᵢ^{l}, hⱼ^{l}: j∈ [symbol] (i), the R-MAXSAT-GNN applies a logic rule to all of those elements in a recursive manner, in resemblance to an addition operation with multiple inputs. It starts operating on two of them and the output is used as a carry or memory for the next operation with the next element until the whole set takes part in the aggregation. The memory is a key element of the aggregation since it contains the important information from all neighbor nodes to help to compute a logic-related output. {hⱼ^{l}: j∈ [symbol] (i)} denotes the set of features entering the node [symbol] ᵢ, where j is the neighbor node index. In an embodiment of the present invention, the aggregation takes the following form:

mᵢ^{k}=MaxSAT_{M}^{3d}^{ₗ}(mᵢ^{k-1},hⱼ^{l})∀j∈ [symbol] (i) (5)

hᵢ^{l+1}=mᵢ^{|} [symbol] ^{(i)|},mᵢ⁰=hᵢ^{l} (6)

where mₖ is the message/memory that aggregates the information from the neighboring nodes for the ego-node, whose feature, hᵢ^{l}, can be used as the initial state. The center node feature hᵢ^{l} in Equation (6) can be removed, as for example in the node missing data experiment discussed below, and replaced with the first neighbor node's feature.

In an embodiment, the present invention can use canonical ordering. In Equation (5), the nodes do not have a predefined order. Thus, to implement an equivariant or invariant message passing method for graph data (to the group of permutations over the nodes), an embodiment of the present invention provides to order the features before they are processed sequentially. This ordering consists of mapping the binary representation encoded in the features to the real numbers and sorting the neighbors in decreasing order. Whenever two or more nodes have the same feature's values, the relative order is not relevant for the permutation invariant property, since the result of the node's features aggregation of Equation (5) is independent of the permutation of these nodes. While this ordering is fixed, it could be easily extended using a self-attention mechanism, similar to the attention bit.

When aggregating the features, embodiments of the present invention use an attention bit, or a logic attention bit. This bit is used to help the solver to decide if the message should be processed or not. A model that uses the attention bit is also referred to herein as RA-MAXSAT-GNN. The attention bit is computed between the center node and each of its neighbors. The attention bit is an additional input to Equation (5) as follows:

aⱼᵢ^{l}=σ(hⱼ^{lT}W^{l}hᵢ^{l}−b^{l}) (7)

mᵢ^{k}=MAXSAT_{M}^{3d}^{ₗ}⁺¹(mᵢ^{k-1},aⱼᵢ^{l},hⱼ^{l})∀j∈ [symbol] (i) (8)

where σ is the non-linear Sigmoid function, W^{l}∈ [symbol] ^{d}^{ₗ}^{xd}^{ₗ}, b^{l}∈ [symbol] ^{d}^{ₗ} are trained parameters and mᵢ^{k} is the memory of the aggregation related to node i at step k, and dₗ is the feature dimension of the l-layer. For the case that the central node feature is missing, a self-attention bit aⱼ^{l}−σ(hⱼ^{lT}W^{l}hⱼ^{l}) is used, and the attention would provide self-filtering information for the SAT problem. The attention bit aⱼᵢ^{l} could also be used for ordering the nodes. For simplicity, fixed ordering could also be used.

According to an embodiment of the present invention, batch aggregation can be used in addition or alternatively to recursive aggregation. The recursive aggregation of Equation (5) suffers from various technical limitations typical of recursive architectures, since the output is only observed after the last iteration or the probability uncertainties of the variables grows at each iteration. In both cases, the SAT-NET solver is forced to work with non-deterministic features multiple times which makes the problem highly non-convex and potentially suffers from a vanishing gradient similar to recurrent networks. This makes a logic-based decision less accurate. To evaluate the capability of the recursive aggregation to be trained end-to-end over multiple recursions steps, an embodiment of the present invention introduces an additional model batch, also referred to herein as MAXSAT-GNN (B-MAXSAT-GNN), that computes outputs over K neighboring nodes' features at once in a single forward pass, where K is fixed to the maximum node degree of the network. Therefore, node features are ordered and concatenated as follows:

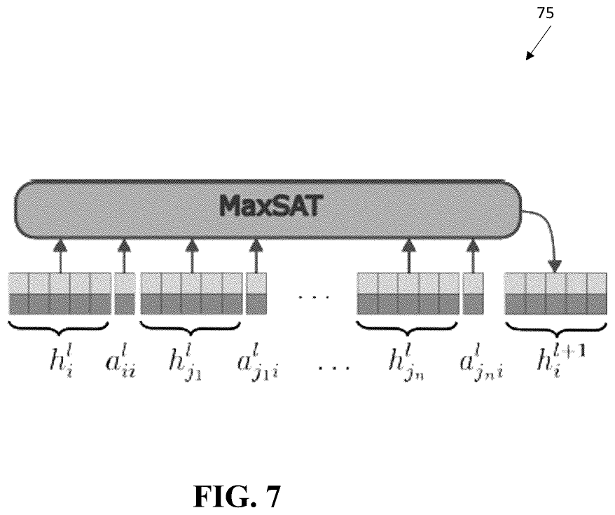

hᵢ^{l+1}=MAXSAT_{M}^{(n+2)d}^{ₗ}(ϕ(hᵢ^{l},hⱼ_{₁}^{l}, . . . ,hⱼ_{ₙ}^{l})),j∈ [symbol] (i)n=| [symbol] (i)| (9)

where ϕ refers to an ordering function. This model only requires one evaluation and does not require hidden states, thus improving training stability. However, when the degree of the node increases, the size of the MAXSAT problem increases. For larger graphs, it is possible to use K-neighbors sampling to reduce the size of the MAXSAT problem. When a node has less than K neighbors, the missing node's feature inputs are substituted with a default value h̅₀, which can either be set to an all zeros vector or learned during training. A visualization of the batch version of the MAXSAT solver B-MAXSAT-GNN, also using attention bits, is shown in FIG. 7, where multiple nodes' features are considered by a single MAXSAT solver 75 at once. The inputs include the features hⱼₙ^{l} and the respective attention bits aⱼₙᵢ^{l} which indicate which of the features hⱼₙ^{l} should be used, that are aggregated as hᵢ^{l+1}.

Table 1 below shows the performance of the recursive and batch embodiments of the present invention from experiments in terms of accuracy for the addition of 5-bit numbers and multiplication with modulo of 5-bit numbers. The best and second best results (if overlaps statistically) are reported, where the top results are also underlined. The error, expressed as standard deviation, is reported in parenthesis and represents the last relevant digits. For example 1.234±0.050 is represented as 1.234(50). The dash represents that B-MAXSAT-GNN is equivalent to R-MAXSAT-GNN.

TABLE 1

| | Method/task | | | | | |
|---|---|---|---|---|---|---|
| | Addition | | | Multiplication | | |
| Trained/tested on | 2→2 | 3→3 | 4→4 | 2→2 | 3→3 | 4→4 |
| R-MAXSAT-GNN | 1.0000(000) | 0.9284(532) | 0.8196(493) | 0.9633(055) | 0.9554(42) | 0.9030(2) |
| B-MAXSAT-GNN | — | 0.9958(008) | 0.9859(105) | — | 0.9586(3) | 0.9758(018) |
| LSTM | 0.8254(267) | 0.4787(310) | 0.7109(47) | 0.8000(286) | 0.8392(64) | 0.8859(58) |
| GRU | 0.8894(280) | 0.7779(600) | 0.7670(30) | 0.8196(54) | 0.8509(54) | 0.8848(19) |
| GCN | 0.5753(158) | 0.6427(56) | 0.6735(21) | 0.6291(51) | 0.7171(40) | 0.7907(2) |
| GAT | 0.7946(247) | 0.7713(24) | 0.7690(78) | 0.7917(204) | 0.8313(35) | 0.8709(31) |
| GIN | 1.0000(000) | 0.9999(001) | 0.9990(011) | 0.8070(106) | 0.8321(15) | 0.8433(17) |

The experiments demonstrate the technical improvements enabled by the MAXSAT-GNNs models. They focus on the ability to aggregate features, assign a suitable node label, and finally, find out if these node updates can be used for graph classification. In order to empirically demonstrate the improved computational performance, the MAXSAT-GNNs were compared to a variety of baselines that have the same desired features. To evaluate the sequential processing, based on recursions with internal states, two recursive networks were considered, in particular long short-term memory (LSTM) and gated recurrent unit (GRU) networks. They use a hidden state that is passed to further recursions and regulates the conservation and propagation of information. For message passing on graph structures, the standard GCN, the GAT convolution, which contains an attention mechanism to assign weights to edge messages, and the graph isomorphism network (GIN), which improves graph neural network's expressive power, were used for comparison.

The experiments also tested the ability to learn arithmetic: addition and multiplication. To support the discovery that logical reasoning can be found in common machine learning problems, the learning capability of arithmetic operations of both MAXSAT approached according to embodiments of the present invention and existing approaches were compared. Referring to basic operations performed on paper by writing the numbers on rows and applying specific rules to their columns, the ability of the MAXSAT-GNNs in learning those rules was tested. In particular, two experiments were performed: 1) addition of 2, 3, and 4 numbers; and 2) multiplication with modulo of 2, 3, and 4 numbers. The synthetic datasets consist of numbers in binary representation with a length of five bits (integer numbers from 0 to 31). For the addition, all possible pairs, triplets, and quadruplets were considered whose sum does not exceed 31. For the multiplication, all possible pairs, triplets, and quadruplets were considered. The labels are set to be the result of addition/multiplication with modulo 32 of those numbers. The recurrent networks and the MAXSAT-GNNs are tested by a simple forward pass on the set of numbers. To test those sets on the graph-based benchmarks according to embodiments of the present invention, a star graph dataset is constructed (from the previous sets) with an unlabeled center node whose neighbors correspond to the numbers to be operated. The output after a message aggregation should give an insight into their ability to learn the arithmetic operation being studied.

The results of learning arithmetic are summarized in Table 1 for addition and for multiplication and shows the mean accuracy per bit of the binary rounded results given by the models. In general, it was observed that the model according to embodiments of the present invention (MAXSAT-GNNs) learns much better arithmetic operations than recurrent networks such as GRU and LSTM. This is evidence that the MAXSAT-GNNs are more capable of encoding logic functions and carrying them across a memory state. Also, taking a general view of the results of the graph-based convolutions (GCN and GAT), it was observed that the MAXSAT-GNNs have more power to aggregate messages on a logic-based setting, which is not based only on a sum aggregation such as the GCN and GAT. Taking a look at the specific results, in addition, it was observed that the MAXSAT-GNNs give satisfactory results which exceed the accuracy of most existing approaches, and in some cases have the highest accuracy, in this task. When training on pairs of numbers, the R-MAXSAT-GNN achieves a perfect score together with the GIN.

Table 2 below shows the accuracy results for the addition of 5-bit numbers, where the generalization (out-distribution) is tested, and where the models are trained on 2, 3, 4 number-sets. The best and second best results (if overlaps statistically) are reported, where the top results are also underlined. The accuracy is reported as in Table 1. The dash represents when B-MAXSAT-GNN cannot be used since the number of operations is larger than K.

TABLE 2

| | Training on 2, 3, 4 number set (addition, out-domain evaluation) | | | | | |
|---|---|---|---|---|---|---|
| Tested on | 2→3 | 2→4 | 3→2 | 3→4 | 4→2 | 4→3 |
| R-MAXSAT-GNN | 1.0000(000) | 0.9990(015) | 0.8010(1783) | 0.7875(1379) | 0.6508(1529) | 0.6438(1927) |
| B-MAXSAT-GNN | — | — | 0.9938(059) | — | 0.9379(578) | 0.9709(247) |
| LSTM | 0.6027(1481) | 0.5337(1268) | 0.5870(526) | 0.4787(310) | 0.5886(40) | 0.6393(73) |
| GRU | 0.6903(233) | 0.6034(261) | 0.5957(1301) | 0.5332(1624) | 0.5577(519) | 0.6304(167) |
| GCN | 0.6387(61) | 0.6727(36) | 0.5918(258) | 0.6736(16) | 0.6013(340) | 0.6384(39) |
| GAT | 0.6075(91) | 0.5440(150) | 0.6421(189) | 0.6654(76) | 0.7038(147) | 0.6688(79) |
| GIN | 0.9199(44) | 0.8228(82) | 1.0000(000) | 0.9679(039) | 0.9987(022) | 0.9999(002) |

Table 3 below shows the accuracy results for the multiplication with modulo of 5 bit numbers, where the generalization (out-distribution) is tested, and where the models are trained on 2, 3, 4 number-sets. The best and second best results (if overlaps statistically) are reported, where the top results are also underlined. The accuracy is reported as in Table 1

TABLE 3

| | Training on 2, 3, 4 number sets (multiplication, out-distribution) | | | | | |
|---|---|---|---|---|---|---|
| Tested on | 2→3 | 2→4 | 3→2 | 3→4 | 4→2 | 4→3 |
| R-MAXSAT-GNN | 0.9445(048) | 0.9409(066) | 0.7221(1060) | 0.9013(543) | 0.7884(39) | 0.8544(1) |
| B-MAXSAT-GNN | — | — | 0.9306(016) | — | 0.9218(036) | 0.9541(014) |
| LSTM | 0.7654(334) | 0.7462(367) | 0.6514(134) | 0.8001(171) | 0.6556(313) | 0.7676(443) |
| GRU | 0.7539(288) | 0.7707(489) | 0.7672(178) | 0.8699(167) | 0.7063(568) | 0.8037(230) |
| GCN | 0.7160(16) | 0.7909(4) | 0.6116(127) | 0.7903(7) | 0.6128(73) | 0.7121(28) |
| GAT | 0.7426(174) | 0.7226(440) | 0.7122(78) | 0.8499(33) | 0.6963(183) | 0.7891(45) |
| GIN | 0.5290(59) | 0.4970(68) | 0.5945(256) | 0.6138(45) | 0.6278(43) | 0.7165(25) |

It was observed that adding elements to the recursion makes the performance of the R-MAXSAT-GNN drop by 7.2% and 18.0%. GIN maintains its almost perfect score when training on quadruplets. However, the B-MAXSAT-GNN is still capable to capture the addition operation while maintaining its performance over 98.5% when it is trained on quadruplets.

Thus, it can be concluded from this that the R-MAXSAT-GNN is sensible to lose information when the input has more elements. This is supported when looking at the uncertainty of the results. B-MAXSAT-GNN has more stable results while the recursive version only sometimes achieved similar scores (and could not learn in the others). For the multiplication task, R-MAXSAT-GNN achieves the best accuracy score when training with pairs. As before, B-MAXSAT-GNN has the peculiarity that the results stay similar, over 95.8%, with the three datasets. In general, however, it was observed that the MAXSAT-GNNs computationally outperformed most, and in many cases all, of the existing approaches on the different datasets.

To determine the generalization of arithmetic learned operations, it was explored if the models according to embodiments of the present invention can generalize the arithmetic operation on a different aggregation size, by testing them with the other datasets that were not used for training (for example, the MAXSAT-GNN that was trained with pairs of numbers tested on triplets and quadruplets). The results are shown in Table 2 and Table 3. For addition, it was observed in general that the R-MAXSAT-GNN is able to generalize when it was trained on pairs, but in the other experiments, they are not, showing decreases in performance over 12%. On the other hand, B-MAXSAT-GNN proves to be more successful in this task, maintaining the ability to learn pair multiplication at scores of 99.4% and 93.7% in the triplet and quadruplet experiments respectively. Unfortunately, this achievement is obscured by the fact the GIN is able to generalize in all cases with scores over 99%. Nonetheless, the MAXSAT-GNNs outperformed the other existing approaches and offer other technical improvements discussed herein over GINs.

A similar generalization behavior was observed on the multiplication task with the MAXSAT-GNNs. In contrast to its recursive version, the accuracy of B-MAXSAT-GNN does not decrease more than 3% for the pairs and triplet experiments and it decreases slightly more, by 5.4%, when it is trained on four numbers and tested on two.

Table 4 below shows the accuracy performance in recovering the missing node features on the molecular datasets. The best and second best results (if overlaps statistically) are reported, where the top results are also underlined. The accuracy is reported as in Table 1.

TABLE 4

| | Node Missing Data | | |
|---|---|---|---|
| | MUTAG | Mutagenicity | ENZYMES |
| R-MAXSATGNN | 0.9372(031) | 0.8968(009) | 0.7123(178) |
| *B-MAXSATGNN | 0.9201(22) | 0.8221(18) | 0.7266(045) |
| RA-MAXSATGNN | 0.9365(002) | 0.8962(010) | 0.7269(046) |
| GCN | 0.9165(17) | 0.7637(92) | 0.7164(36) |
| GAT | 0.9086(40) | 0.8182(1) | 0.7202(43) |
| GIN | 0.9134(109) | 0.8263(8) | 0.7152(41) |

As a second step, knowing that the R-MAXSAT-GNN is capable to learn an arithmetic operation on binary numbers, real datasets whose features are represented in binary or one-hot encoding were also tested following the assumption that there is some logical operation, similar to an arithmetic operation, that can be performed on messages toward a specific node. This operation would help to discern newer or missing node representations on a graph, for instance, to find node labels when data is not available, from the neighborhood information. Missing node data prediction according to an embodiment of the present invention comprises predicting node features based on the information that can be gathered from their neighborhood. It is a useful task when the dataset is incomplete, but there is still enough information to capture the missing data.

The experiments for recovering the missing node features were set up on three datasets from the benchmarks for graph learning, in particular the TUDataset (MUTAG), Mutagenicity, and ENZYMES datasets. For training, 20% of all the nodes were set to be test nodes where their features are set to zero, meaning that they are unknown. The rest of the nodes are the training nodes. During each training iteration (mini-batch), 10% of the training nodes were set to zero, and their features were inferred at training time. A similar architecture as in the previous experiment was used, composed of one layer of message aggregation with the three models according to embodiments of the present invention and the baselines to gather neighborhood information; and one linear layer for non-probabilistic outputs. The labels of the nodes are one-hot encoded features. Therefore, the cross entropy loss was optimized for multiclass classification and performance was evaluated using classification accuracy after applying a soft-max layer to the output.

As shown in Table 4, the ability of the MAXSAT-GNNs to find the correct label based on closest neighbor message passing is similar to or slightly better than the other models. On the MUTAG dataset, the SAT-NET solver achieves an accuracy of 93.7% which is somewhat better than the results of the baselines which reach 91.3%. This difference is more remarkable in the case of the Mutagenicity dataset where the difference is over 7% with respect to the best of the existing graph neural networks. The results achieved on the ENZYMES dataset also exhibit some improvement over the baselines.

The performance of embodiments of the present invention were also investigated for the task of graph classification. Here, three datasets from the same graph learning benchmarks were considered: MUTAG, Mutagenicity, and PROTEINS. The first two contain graphs with one-hot encoded features. The PROTEINS dataset consists of an integer number plus a one-hot encoded three-class features. That integer number was “clamped” between the values 0 and 31, the interval where most of the values lie, and subsequently was converted into a binary 5-bit vector and was eventually concatenated to the rest of the features. All those datasets have a global graph label with two different classes. For training and metric evaluation, they were split into a training set (80%) and a test set (20%) respectively.

The architecture for the MAXSAT-based message passing according to embodiments of the present invention consisted of two layers of message aggregation with RA-MAXSAT-GNN and B-MAXSAT-GNN. A global pooling uses the max function, which should resemble an OR gate. One linear dense layer followed by a Sigmoid function provides for probabilistic outputs. The baselines (GCN, GAT, and GIN) used the same architecture. The models according to embodiments of the present invention were trained using the so-called ADAM optimizer and the binary cross entropy loss. The results were also evaluated using the accuracy metric.

In complex tasks such as graph classification where multiple aggregations are involved, the MAXSAT-based models according to embodiments of the present invention are capable of performing similarly to or better than the baselines. The results are shown in Table 5 below. The performance of B-MAXSAT-GNN is shown, although not an adequate model for performing aggregation, especially for datasets such as PROTEINS, where the maximum graph degree is considerably larger than the other datasets. It was observed that the models according to embodiments of the present invention outperform on average the baselines on the MUTAG dataset reaching 92.1% in accuracy, while in the others the results overlap. This demonstrates that graph classification can be modeled with SAT solvers where an internal logical representation of the nodes is capable of classifying the graphs. In Table 5, the standard deviation is reported with the last n position. The best and second best results (if overlaps statistically) are reported, where the top results are also underlined. The accuracy is reported as in Table 1.

TABLE 5

| | Graph Classification | | |
|---|---|---|---|
| | MUTAG | Mutagenicity | PROTEINS |
| B-MAXSATGNN | 0.9211(456) | 0.7949(123) | — |
| RA-MAXSATGNN | 0.9035(152) | 0.8078(130) | 0.7227(262) |
| GCN | 0.7632(912) | 0.7919(131) | 0.7047(324) |
| GAT | 0.7979(405) | 0.7905(87) | 0.6811(419) |
| GIN | 0.8502(402) | 0.8150(149) | 0.6922(475) |

Deep learning on graphs and in particular graph neural networks has been extensively studied in the last few years. The predominant paradigm is message passing, which propagates information using a learnable non-linear function on the graph. Among the most popular architecture is GCN, where the graph is represented using the normalized adjacent matrix, GAT, where the weights of multiple heads on the node are mixed with learnable functions, and GIN, which achieves the same discriminative power level of Weisfeiler-Lehman (WL) isomorphism test. Another architecture referred to as RNNLogic uses an expectation-maximization-based algorithm to learn a set of rules for reasoning on knowledge graphs. However, contrary to the approach according to embodiments of the present invention, the model is not differentiable. Whether to use a fixed canonical ordering, or a fixed function according to an embodiment of the present invention, can depend on the current node's feature. To overcome the limited expressive power of graph neural networks, alternative approaches have been proposed where WL-k (k≥1) networks are described, whose complexity, however, increases exponentially with the expressive level k.

Embodiments of the present invention provide to model the properties of graph structured data using logic rules which can be learned through end-to-end training. Embodiments of the present invention exploit the structure of message passing and provide for an invariant-equivariant architecture based on an ordering function and a flexible attention mechanism. Multiple experiments empirically demonstrated that the MAXSAT-GNN approaches according to embodiments of the present invention learn rules for arithmetic operations, while on molecular datasets is capable of estimating missing node features and classifying graphs.

An alternative way to model reasoning is to use discrete latent variables. To integrate discrete variables into traditional differentiable architectures, various gradient estimations have been proposed. However, these models only mimic the discrete nature of the variables and do not capture the underlying reasoning mechanism. While a combinatorial problem can be solved using heuristics, neural combinatorial optimization methods use deep neural networks to learn adaptable heuristics either using supervised learning or reinforcement learning.

In embodiments of the present invention, the dataset's input features are considered discrete and the dataset is generated at least partially according to some logic rules. If the input data is described with continuous variables and quantization of the input values does not introduce high distortion, then the model can be advantageously used. In some situations, it is possible to employ an initial nonlinear layer to encode the features either into discrete features or into continuous values in [0, 1].

Embodiments of the present invention model the relationship of nodes' (or edges') features in the neighborhood of a node of a graph. When using multiple layers, it is possible to extend the scope of the learned rules to a larger number of features.

For the addition experiments, the number of bits was set to 5, and thus the total number of variables is n=15, where two numbers are used as input and one variable is the output. The number of auxiliary variables was set to aux=12, while the number of clauses was set to m=40. The number of applications depends on the experiment N=1, 2, 3. The same network is applied recursively. With the B-MAXSAT-GNN, the missing input variables are set to zero.

For the multiplication experiments, the number of bits was set to 5, and thus the total number of variables is n=15, where two numbers are used as input and one variable is the output. The number of auxiliary variables was set to aux=16, while the number of clauses was set to m=88. The number of applications depends on the experiment N=1, 2, 3. The same network is applied recursively. With the B-MAXSAT-GNN, the missing input variables are set to zero, while aux=100, m=100, and n=5+5N.

For the graph classification experiments, the total number of variables is n, the number of auxiliary variables is aux, and the number of clauses m, and the number of applications depends on the dataset, where for Mutagenicity N=5, aux=20, m=20, n=42, for PROTEINS N=26, aux=12, m=[12, 20], n=24 and for MUTAG N=28, aux=12, m=[24, 24], n=27. The same network is applied recursively as an aggregation function, while using two layers in the experiments. With the B-MAXSAT-GNN, the missing input variables are set to zero. GCN has a similar architecture with two layers and 64 channels, while GAT has 16 channels, and GIN has 7 channels. An additional network generates the graph classification from the node features. For training, the ADAM gradient update and lr=1e⁻³ were used, while the training loss function was the binary cross entropy loss.

For the node missing features experiments, as for the graph classification experiments, the total number of variables is n, the number of auxiliary variables is aux, the number of clauses m, and the number of applications depends on the dataset, where for Mutagenicity N=5, aux=20, m=20, n=42, for PROTEINS N=26, aux=12, m=[12, 20], n=24 and for MUTAG N=28, aux=12, m=[24, 24], n=27. The same network is applied recursively as an aggregation function, while using two layers in the experiments. With the B-MAXSAT-GNN, the missing input variables are set to zero. GCN has a similar architecture with two layers and 64 channels, while GAT has 16 channels, and GIN has 7 channels. For training, the ADAM gradient update and r=1e⁻³ were used, while the training loss function was the binary cross entropy loss. The difference with respect to the graph classification is that there was no graph pooling function. Rather, the node features for the missing node features were predicted directly.

In an embodiment, the present invention provides for a differentiable satisfiability network. In MAXSAT problems, one is interested to find the assignment of n binary variables xᵢ∈{−1,1}, i=1, . . . , n concerning m given clauses, or:

$${max}_{x ∈ {\{ - 1 , 1 \}}^{n}} {\sum }_{j ∈ [ m ]} {⋁}_{i ∈ [ n ]} {1}_{{s}_{ji} {x}_{i} > 0} \qquad ( 10 )$$

where sⱼᵢ∈{−1, 0, +1} are the clauses of the MAXSAT problem. If sⱼᵢ=0 the variable i is ignored in the j clause, while xᵢ=+1 is associated with a true value and xᵢ=−1 to a false value, thus sⱼᵢ=−1 negates the variable xi. MAXSAT is one of the extensions of the SAT problem, where all the clauses need to be true. Relaxing the SAT is useful to find the closest solution that satisfies most of the clauses.

The problem in Equation (10) can be relaxed into an SDP problem as follows:

$${min}_{V ∈ {ℝ}^{k \times ( n + 1 )}} 〈 {S}^{T} S , {V}^{T} V 〉 , s . t . ‖ {v}_{i} ‖ = 1 ∀ i ∈ \{ ⊤ , 1 , … , n \} , \qquad ( 11 )$$

where for each input variable xᵢ is associated with unitary vector vᵢ∈ [symbol] ^{k} of dimension k, with some k>\sqrt{2n}, with k is the size of the embedded space, while n is the number of variables. The variable v_{T} is used as a reference and is associated with true logic value. The normalized matrix S=[s_{T}, s₁, . . . , sₙ]/diag(1/\sqrt{4|sⱼ|}∈ [symbol] ^{m×(n+1)} encodes the clauses, while the unitary matrix V∈ [symbol] ^{K×(k+1)} encodes the variables.

After solving the relaxed problem, the next step is to compute the logic variables from the vectors that minimize Equation (11) as follows:

$$P ( {x}_{i} = 1 ) = \frac{1}{π} arccos ( - {v}_{i}^{T} {v}_{⊤} ) \qquad ( 12 )$$

The probability measures the angle between the vector associated with the true value and the vector associated with the i variable, indeed [symbol] ᵢ^{T} [symbol] _{T}=cos(πxᵢ). To recover the discrete value, the sign of the probability is computed, i.e. xᵢ=sign (P(xᵢ=1)).

For transforming the logic variables to the relaxed vectors, vectors are generated from the logical values as [symbol] ᵢ=−cos(πxᵢ) [symbol] _{T}+sin(πxᵢ)P_{T} [symbol] ᵢ^{rand}, where Pᵢ=I_{K}− [symbol] ᵢ [symbol] ᵢ^{T} is the projection matrix on the vector [symbol] ᵢ, while [symbol] ᵢ^{rand}, is a random unit vector.

For solving the SDP relaxation, the solution of Equation (11) is given as the fix point as follows:

$${v}_{i} = - \frac{{g}_{i}}{‖ {g}_{i} ‖} \qquad ( 13 )$$

where gᵢ=V S^{T} sᵢ−∥sᵢ∥² [symbol] ᵢ=VS^{T} sᵢ− [symbol] ᵢsᵢ^{T}sᵢ.

Additional auxiliary variables (aux) may be needed to help the SDP relaxation to converge to the minimal point. These variables do not have a specific meaning, but they are akin to reformation using additional variables of the original problem, this reformulation, while not changing the original truth table, helps the underlying minimization procedure to converge.

With respect to computational complexity of solving the SDP relaxation, the overall complexity of the two algorithms is O(Tkmn), with k the expanded dimension, n the number of variables and m the number of clauses. At the same time, T represents the number of iterations of the algorithm. During the experiments, T was set to a small number, e.g. T=40.

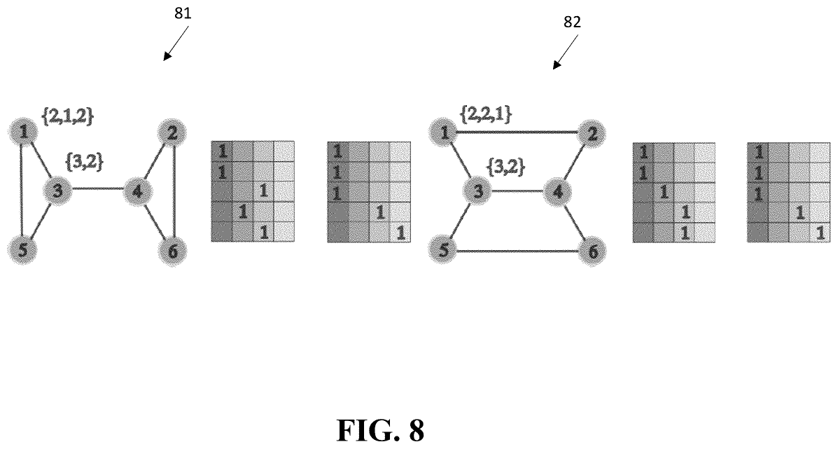

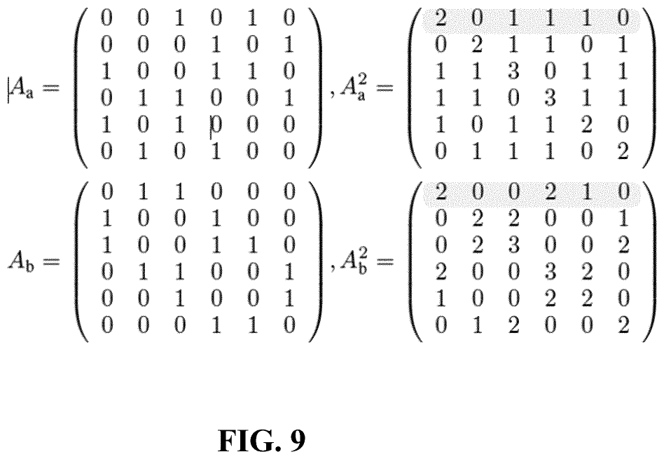

FIG. 8 further demonstrated the improvements to computer functionality and performance provided by embodiments of the present invention. In particular, FIG. 8 shows two graphs 81, 82 that are not distinguishable from each other by existing graph neural networks, and are also not distinguishable by the Weisfeiler-Lehman isomorphism test (1-WL test). Indeed the neighborhood of the nodes 1-6 in both graphs is the same, so the aggregation function will return the same result. However, by propagating the multi-hop distance in binary format, then it is possible to reason on the relative distance of nodes. In a simplified example, consider the adjacent matrix A of the two networks, it is possible to use the one-hop and two-hop adjacent matrices AₐAₐ² of the first graph (top two matrices in FIG. 9) and A_{b}, A_{b}² of the second graph (bottom two matrices in FIG. 9). It is possible to use the rows of the two-hop adjacent matrix to reason on the node contribution. For example, the node 1 (the top row of the matrix Aₐ²) has one entry equal to 2 and three equal to 1, while in the second graph (the top row of the matrix A_{b}²), has two entries equal to 2 and one equal to 1. This information can thus be used to classify the node or the graph. An existing graph neural network would not be able to count the entries.

The following publications are hereby incorporated by reference herein:
Michael M. Bronstein, Joan Bruna, Taco Cohen, and Petar Veličlović. Geometric Deep Learning: Grids, Groups, Graphs, Geodesics, and Gauges. arXiv preprint arXiv:2104.13478, May 2021.
Justin Gilmer, Samuel S. Schoenholz, Patrick F. Riley, Oriol Vinyals, and George E. Dahl. Neural Message Passing for Quantum Chemistry. arXiv preprint arXiv:1704.01212, June 2017.
Thomas N. Kipf and Max Welling. Semi-supervised classification with graph convolutional networks. arXiv preprint arXiv:1609.02907, 2016.
Federico Errica, Marco Podda, Davide Bacciu, and Alessio Micheli. A fair comparison of graph neural networks for graph classification. arXiv preprint arXiv:1912.09893, 2019.
Emanuele Rossi, Henry Kenlay, Maria I Gorinova, Benjamin Paul Chamberlain, Xiaowen Dong, and Michael Bronstein. On the unreasonable effectiveness of feature propagation in learning on graphs with missing node features. arXiv preprint arXiv:2111.12128, 2021.
Hoang Nt and Takanori Maehara. Revisiting graph neural networks: All we have is low-pass filters. arXiv preprint arXiv:1905.09550, 2019.
Deli Chen, Yankai Lin, Wei Li, Peng Li, Jie Zhou, and Xu Sun. Measuring and relieving the over-smoothing problem for graph neural networks from the topological view. In Proceedings of the AAAI Conference on Artificial Intelligence, volume 34, pages 3438-3445, 2020.
Jake Topping, Francesco Di Giovanni, Benjamin Paul Chamberlain, Xiaowen Dong, and Michael M Bronstein. Understanding over-squashing and bottlenecks on graphs via curvature. arXiv preprint arXiv:2111.14522, 2021.
Uri Alon and Eran Yahay. On the bottleneck of graph neural networks and its practical implications. arXiv preprint arXiv:2006.05205, 2020.
Christopher Morris, Martin Ritzert, Matthias Fey, William L Hamilton, Jan Eric Lenssen, Gaurav Rattan, and Martin Grohe. Weisfeiler and leman go neural: Higher-order graph neural networks. In Proceedings of the AAAI conference on artificial intelligence, volume 33, pages 4602-4609, 2019.
Haggai Maron, Heli Ben-Hamu, Hadar Serviansky, and Yaron Lipman. Provably powerful graph networks. Advances in neural information processing systems, 32, 2019.
Marin Vlastelica Pogancic, Anselm Paulus, Vit Musil, Georg Martius, and Michal Rolinek. Differentiation of blackbox combinatorial solvers. In International Conference on Learning Representations, 2019.
Quentin Cappart, Didier Chetelat, Elias Khalil, Andrea Lodi, Christopher Morris, and Petar Veličlović. Combinatorial optimization and reasoning with graph neural networks. arXiv preprint arXiv:2102.09544, 2021.
Stuart J Russell. Artificial intelligence a modern approach. Pearson Education, Inc., 2010.
Michel X. Goemans and David P. Williamson. Improved approximation algorithms for maximum cut and satisfiability problems using semidefinite programming. J. ACM, 42(6):1115-1145. ISSN 0004-5411. doi: 10.1145/227683.227684, 1995.
Po-Wei Wang and J Zico Kolter. Low-rank semidefinite programming for the max2sat problem. In Proceedings of the AAAI Conference on Artificial Intelligence, volume 33, pages 1641-1649, 2019.
Po-Wei Wang, Wei-Cheng Chang, and J. Zico Kolter. The mixing method: low-rank coordinate descent for semidefinite programming with diagonal constraints. arXiv preprint arXiv: 1706.00476, 2017.
Sepp Hochreiter and Jürgen Schmidhuber. Long Short-Term Memory. Neural Computation, 9(8):1735-1780, 11 1997. ISSN 0899-7667. doi: 10.1162/neco.1997.9.8.1735, 1997.
Mathias Niepert, Mohamed Ahmed, and Konstantin Kutzkov. Learning convolutional neural networks for graphs. In International conference on machine learning, pages 2014-2023. PMLR, 2016.
Kyunghyun Cho, Bart Van Merrienboer, Dzmitry Bandanau, and Yoshua Bengio. On the properties of neural machine translation: Encoder-decoder approaches. arXiv preprint arXiv:1409.1259, 2014.
Keyulu Xu, Weihua Hu, Jure Leskovec, and Stefanie Jegelka. How powerful are graph neural networks? arXiv preprint arXiv: 1810.00826, 2018.
Christopher Morris, Nils M Kriege, Franka Bause, Kristian Kersting, Petra Mutzel, and Marion Neumann. Tudataset: A collection of benchmark datasets for learning with graphs. arXiv preprint arXiv:2007.08663, 2020.
Diederik P Kingma and Jimmy Ba. ADAM: A method for stochastic optimization. arXiv preprint arXiv:1412.6980, 2014.
Zhilu Zhang and Mert Sabuncu. Generalized cross entropy loss for training deep neural networks with noisy labels. Advances in neural information processing systems, 31, 2018.
Alessandro Sperduti and Antonina Starita. Supervised neural networks for the classification of structures. IEEE Transactions on Neural Networks, 8(3):714-735, 1997.
Haggai Maron, Heli Ben-Hamu, Nadav Shamir, and Yaron Lipman. Invariant and equivariant graph networks. In International Conference on Learning Representations, 2018.
Christopher Morris, Gaurav Rattan, and Petra Mutzel. Weisfeiler and leman go sparse: Towards scalable higher-order graph embeddings. Advances in Neural Information Processing Systems, 33:21824-21840, 2020.
Christopher Morris and Petra Mutzel. Towards a practical k-dimensional weisfeiler-leman algorithm. arXiv preprint arXiv:1904.01543, 2019.
Eric Jang, Shixiang Gu, and Ben Poole. Categorical reparameterization with gumbel-softmax. arXiv preprint arXiv:1611.01144, 2016.
Chris J Maddison, Andriy Mnih, and Yee Whye Teh. The concrete distribution: A continuous relaxation of discrete random variables. arXiv preprint arXiv:1611.00712, 2016.
Max B Paulus, Chris J Maddison, and Andreas Krause. Rao-blackwellizing the straight-through gumbel-softmax gradient estimator. page 11, 2021.
Chaitanya K Joshi, Thomas Laurent, and Xavier Bresson. An efficient graph convolutional network technique for the travelling salesman problem. arXiv preprint arXiv:1906.01227, 2019.
Wouter Kool, Herke Van Hoof, and Max Welling. Attention, learn to solve routing problems! ICLR, 2019.
Gabor Pataki. On the rank of extreme matrices in semidefinite programs and the multiplicity of optimal eigenvalues. Mathematics of operations research, 23(2):339-358, 1998.
Po-Wei Wang, Priya Donti, Bryan Wilder, and Zico Kolter. Satnet: Bridging deep learning and logical reasoning using a differentiable satisfiability solver. In International Conference on Machine Learning, pages 6545-6554. PMLR, 2019.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for learning logical rules over graph structured data to generate a prediction in a machine learning system, the method comprising:
obtaining graph structured data from a technical application domain of the machine learning system;
training a graph neural network to learn logical rules using message passing; and
generating the prediction in the machine learning system based on the learned logical rules.

2. The method according to claim 1, further comprising obtaining an initial set of logical rules that are usable to solve a satisfiability problem in the technical application domain of the machine learning application, wherein the graph neural network is trained to learn updates to the initial set of logical rules to provide new learned rules.

3. The method according to claim 2, wherein the initial set of logical rules are predefined using domain knowledge.

4. The method according to claim 1, further comprising computing an attention bit that is used to decide whether a feature of a node of the graph neural network is included in the message passing.

5. The method according to claim 4, wherein a plurality of attention bits are computed, each for a respective node of the graph neural network, and wherein the nodes are ordered prior to aggregation by the message passing based on the attention bits.

6. The method according to claim 1, wherein the training is performed end-to-end with a differentiable satisfiability solver.

7. The method according to claim 1, wherein the training is performed using reinforcement learning.

8. The method according to claim 1, further comprising generating two graph sequences from the graph structured data by dropping edges or nodes randomly, wherein the graph neural network generates a representation for each of the graph sequences, and wherein the training is performed using a contrastive loss based on the representations.

9. The method according to claim 8, wherein the loss is built by minimizing a Kullback-Leibler (KL) divergence of the representation, by maximizing mutual information and/or using a cosine similarity function.

10. The method according to claim 1, further comprising ordering nodes of the graph neural network prior to aggregation by the message passing.

11. The method according to claim 10, wherein the ordering is based on values of the features of the nodes.

12. The method according to claim 1, wherein the message passing performed by a node of the graph neural network uses the logical rules to aggregate information from other nodes and/or to transform information from the same node to another layer of the graph neural network.

13. The method according to claim 1, wherein the technical application domain is in medical artificial intelligence, bioinformatics and/or knowledge graphs, and wherein the prediction is an output of the graph neural network trained on a machine learning task that is a node classification, a link prediction and/or a graph classification.

14. A system for learning logical rules over graph structured data to generate a prediction in a machine learning system, comprising one or more hardware processors, configured to provide for execution of the following steps:
obtaining graph structured data from a technical application domain of the machine learning system;
training a graph neural network to learn logical rules using message passing; and
generating the prediction in the machine learning system based on the learned logical rules.

15. A tangible, non-transitory computer-readable medium having instructions thereon which, upon being executed by one or more processors, provides for execution of a method for learning logical rules over graph structured data to generate a prediction in a machine learning system, the method comprising following steps:
obtaining graph structured data from a technical application domain of the machine learning system;
training a graph neural network to learn logical rules using message passing; and
generating the prediction in the machine learning system based on the learned logical rules.
